(19) United States
(12) Patent Application Publication
(10) Pub. No.: US 2020/0130804 A1
(43) Pub. Date: Apr. 30, 2020

(54) ALTERNATIVE AIRCRAFT CONFIGURATIONS FOR FLIGHT CREW AREAS

(71) Applicant: The Boeing Company, Chicago, IL (US)

(72) Inventors: Brian Paul Colletti, Mission Viejo, CA (US); Manuel G. Banda, Santa Ana, CA (US)

(21) Appl. No.: 16/169,495

(22) Filed: Oct. 24, 2018

(51) Int. Cl. B64C 1/14; B64D 45/00; B64C 1/10

(52) U.S. Cl. CPC B64C 1/1407; B64D 11/02; B64C 1/10; B64D 45/0015

(57) ABSTRACT

Embodiments described herein provide for flight crew areas onboard aircraft that are only accessible via a door to the exterior of the aircraft. The flight crew areas may be included within the same section of the fuselage of the aircraft as the aircraft cabin, or may be included within a different section of the fuselage. One embodiment comprises an aircraft that includes an aircraft cabin and a flight crew area. The aircraft cabin is configured for passenger seating. The flight crew area includes a door opening to an exterior of the aircraft that is sized for a person, and a cockpit that is only accessible by a flight crew via the door.

### FIELD

This disclosure relates to the field of aircraft and, in particular, to variations in how a flight crew area is configured onboard the aircraft.

### BACKGROUND

A cockpit (also referred to as a flight deck) is an area typically near the front of an aircraft where a flight crew (e.g., a pilot, a co-pilot, and an engineer) control the aircraft. The cockpit includes flight instruments and controls that enable the pilot or the co-pilot to fly the aircraft. Commercial aircraft typically include an interior door that separates the cockpit from the main passenger cabin. The interior door is fortified to prevent access to the cockpit by unauthorized persons. However, a fortified door may still remain susceptible to entry by unauthorized persons, given sufficient time and tools. Thus, there is a need to allow access to the cockpit by the flight crews, while preventing access to the cockpit by unauthorized persons.

### SUMMARY

Embodiments described herein provide for flight crew areas onboard aircraft that are only accessible via a door to the exterior of the aircraft. The flight crew areas may be included within the same section of the fuselage of the aircraft as the aircraft cabin, or may be included within a different section of the fuselage.

One embodiment comprises an aircraft that includes an aircraft cabin and a flight crew area. The aircraft cabin is configured for passenger seating. The flight crew area includes a cockpit and a door. The door opens directly to an exterior of the aircraft that is sized for a person, and the flight crew area is only accessible via the door.

Another embodiment comprises an aircraft that includes a flight crew area. The flight crew area includes a cockpit that includes a door that opens directly to an exterior of the aircraft, and a lavatory accessible from the cockpit. The cockpit is only accessible via the door.

Another embodiment comprises an aircraft that includes a cockpit and a lavatory. The cockpit includes a door that opens directly to an exterior of the aircraft. The cockpit is only accessible on the aircraft via the door. The lavatory is only accessible from the cockpit.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments are now described, by way of example only, and with reference to the accompanying drawings. The same reference number represents the same element or the same type of element on all drawings.

FIG. 1 depicts a side view of an aircraft in an illustrative embodiment.

FIG. 2 depicts a cut-through front view of the aircraft corresponding to view arrows 2 in FIG. 1 in an illustrative embodiment.

FIGS. 3-10 depicts various configurations of flight crew areas for the aircraft of FIG. 1 in illustrative embodiments.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure are to be construed as being without limitation. As a result, this disclosure is not limited to the specific embodiments or examples described below, but by the claims and their equivalents.

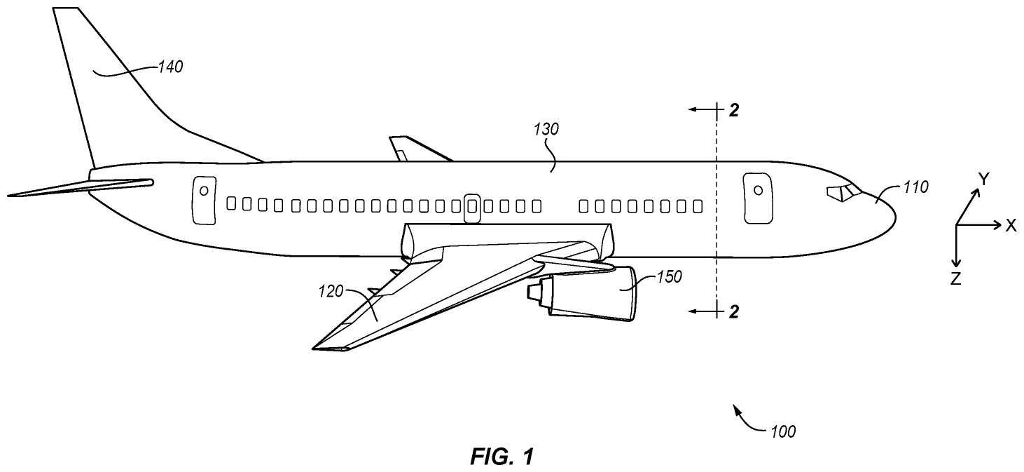

FIG. 1 depicts a side view of an aircraft 100 in an illustrative embodiment. Aircraft 100 includes nose 110, wings 120, fuselage 130, a tail 140, and engines 150. FIG. 1 also illustrates a downward direction (Z) for aircraft 100. Although aircraft 100 has been depicted to have a particular configuration for purposes of discussion, aircraft 100 may have other configurations in other embodiments.

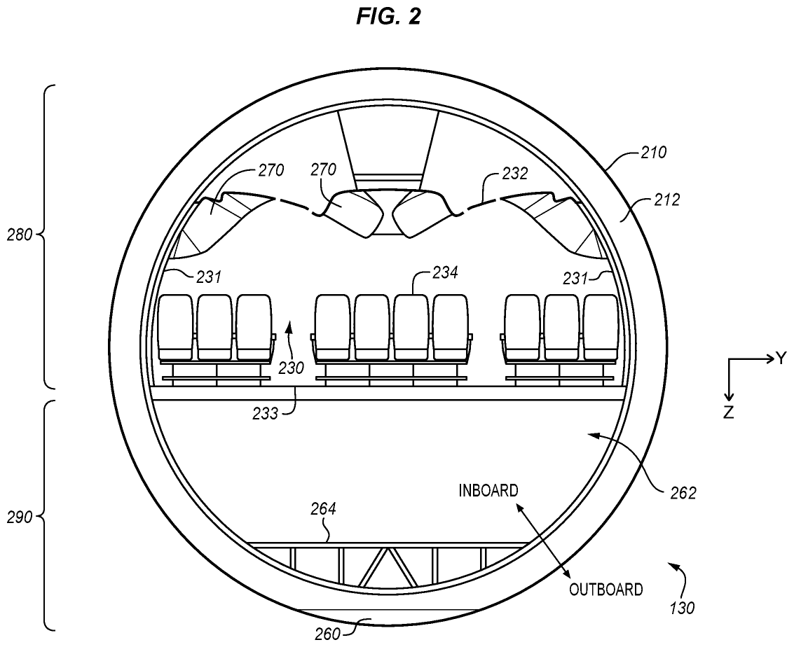

FIG. 2 depicts a cut-through front view of aircraft 100 corresponding to view arrows 2 in FIG. 1 in an illustrative embodiment. In particular, FIG. 2 illustrates a cross sectional view of fuselage 130 for aircraft 100. Fuselage 130 includes an upper section 280, which includes a floor 233, a ceiling 232, and sidewalls 231 that form an aircraft cabin 230. Support members 212 (e.g., comprising hoopwise frames and longitudinally elongated stringers) enforce the shape of fuselage 130 and provide structural support. In this embodiment, passenger seating 234 and storage 270 are also included. Fuselage 130 also includes a lower section 290, which includes drainage 260 located beneath cargo floor 264 of cargo area 262. FIG. 2 further illustrates that an outboard direction that proceeds towards an external surface (e.g., skin 210) of aircraft 100, and an inboard direction that proceeds towards the interior (e.g., aircraft cabin 230) of aircraft 100. As shown in FIG. 2, skin 210 surrounds fuselage 130.

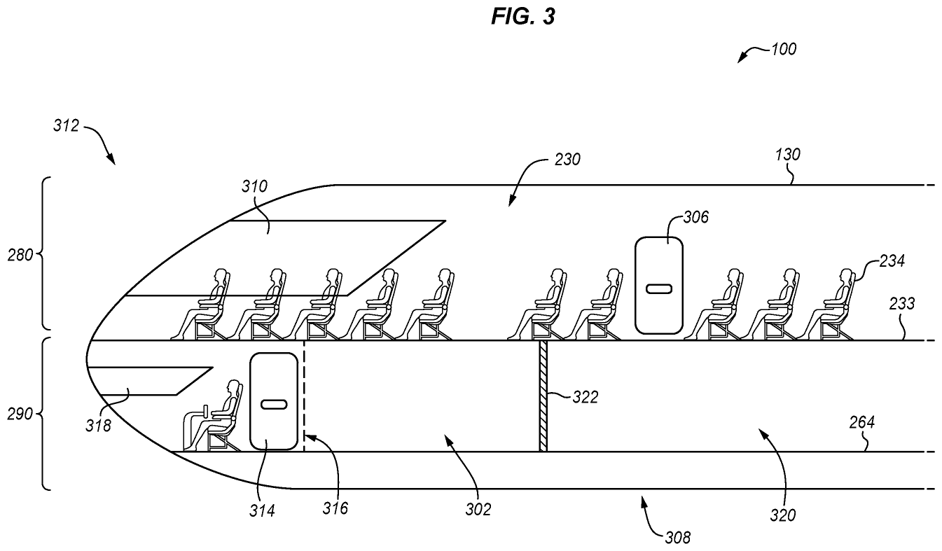

FIGS. 3-10 depicts various configurations for flight crew areas for aircraft 100 of FIG. 1 in illustrative embodiments. As described herein, a flight crew area refers to portions of aircraft 100 that are accessible to a flight crew but not accessible to passengers. Some examples of a flight crew area include a cockpit for operating aircraft 100, a flight deck for operating aircraft 100, etc. Some examples of a flight crew include pilot(s), co-pilot(s), and flight engineer(s). The pilot and/or co-pilot may utilize flight instruments and controls to operate aircraft 100. The flight engineer(s) may be responsible for monitoring and controlling engines 150, providing management functions for fuel onboard aircraft 100, and/or for monitoring and controlling other systems onboard aircraft 100.

FIG. 3 illustrates a configuration for aircraft 100 whereby a flight crew area 302 is position within lower section 290 of aircraft 100. In particular, flight crew area 302 is positioned below floor 233, which forms one boundary of an aircraft cabin 230. Aircraft cabin 230 in this embodiment is configured for passenger seating 234. Aircraft cabin 230 further includes a door 306 which traverses through fuselage 130 to an exterior 308 of aircraft 100 and is sized for a person to allow passengers access to aircraft cabin 230. In some embodiments, aircraft cabin 230 may include an observation window 310 which is proximate to a front 312 of aircraft 100. Observation window 310 may be used by passengers in a first-class or higher than first-class seating area of aircraft cabin 230. One advantage of the configuration illustrated in FIG. 3 is that flight crew area 302 is inherently isolated from aircraft cabin 230 by floor 233, which provides isolation between aircraft cabin 230 and flight crew area 302. Another advantage of the configuration illustrated in FIG. 3 is that aircraft 100 can carry more passengers. Further, the use of observation window 310 in this configuration may allow for a higher tier of seat pricing that exceeds first-class, as observation window 310 provides a premium experience for the passengers onboard aircraft 100.

Flight crew area 302 in this embodiment is formed within an area bounded by floor 233 of aircraft cabin 230 and cargo floor 264. Flight crew area 302 further includes a door 314 that traverses through fuselage 130 and opens directly to exterior 308 of aircraft 100. Flight crew area 302 further includes a cockpit 316 that includes various flight instruments and controls utilized by the flight crew to operate aircraft 100. Cockpit 316 may be referred to as a flight deck in some embodiments.

Door 314 of flight crew area 302 is sized for a person, thereby allowing the flight crew to access to cockpit 316 and flight crew area 302. Further, flight crew area 302 is only accessible through door 314, which prevents unauthorized entry into flight crew area 302 during flight. For instance, during flight operations, flight crew area 302 would be completely isolated from aircraft cabin 230 as it would be impossible for passengers in aircraft cabin 230 to open door 314, since door 314 is only accessible from exterior 308 of aircraft 100.

In some embodiments, cockpit 316 may include a window 318 to exterior 308 of aircraft 100. Window 318 allows the flight crew a visual view towards front 312 of aircraft 100 during flight operations. However, window 318 may be removed in other embodiments. In embodiments where window 318 is removed, exterior cameras (not shown in FIG. 3) may be used to provide a view around aircraft 100 to the pilot(s) and/or co-pilot(s) during flight operations. In some embodiments, aircraft 100 may include a cargo area 320 to allow aircraft 100 to transport cargo. In other embodiments, cargo area 320 may be configured for additional passengers, with flight crew area 302 being isolated from cargo area 320 via a bulkhead wall 322. In some embodiments, bulkhead wall 322 may be a continuous surface that extends from floor 233 to cargo floor 264 and along fuselage 130.

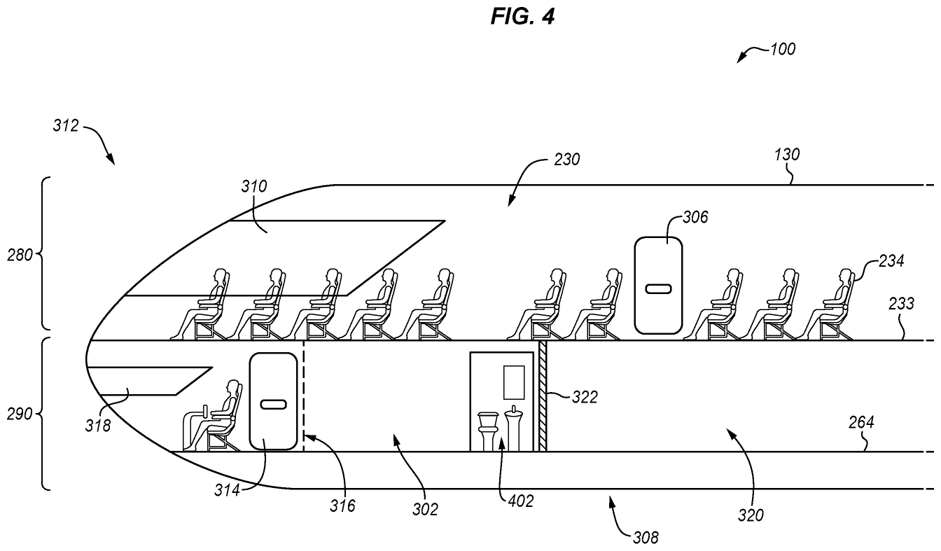

FIG. 4 illustrates a configuration for aircraft 100 whereby flight crew area 302 further includes a lavatory 402 for the flight crew. As flight crew area 302 is isolated from aircraft cabin 230, the typical lavatories within aircraft cabin 230 are not accessible to the flight crew. Further, as lavatory 402 is within flight crew area 302, lavatory 402 is not accessible to passengers within aircraft cabin 230. Lavatory 402 may also be referred to as a bath room. Lavatory 402 may include a sink, a toilet, a shower, or combinations thereof.

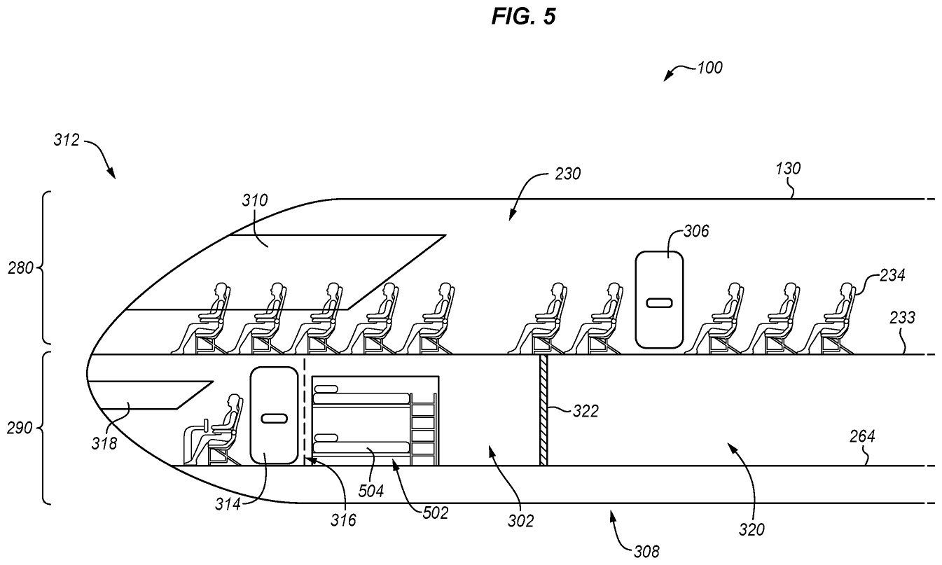

FIG. 5 illustrates a configuration for aircraft 100 whereby flight crew area 302 includes a rest area 502 for the flight crew. Rest area 502 may include beds 504 and/or chairs (not shown) in some embodiments. Rest area 502 may advantageously provide portions of the flight crews the ability to rest and/or sleep during a flight.

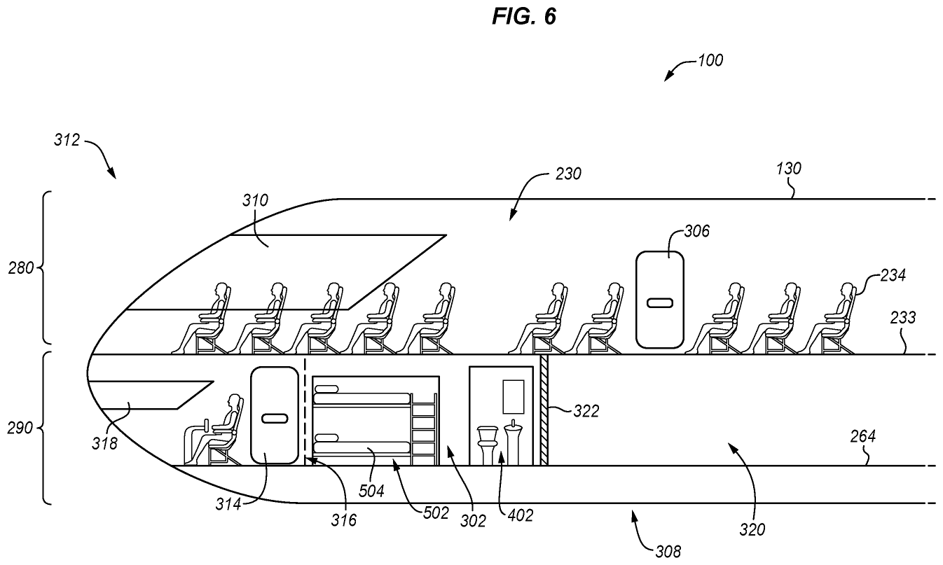

FIG. 6 illustrates a configuration for aircraft 100 whereby flight crew area 302 includes both lavatory 402 and rest area 502. The configuration illustrated in FIG. 6 may be utilized on long distance flights that include flight crews that operate aircraft 100 during different portions of a flight.

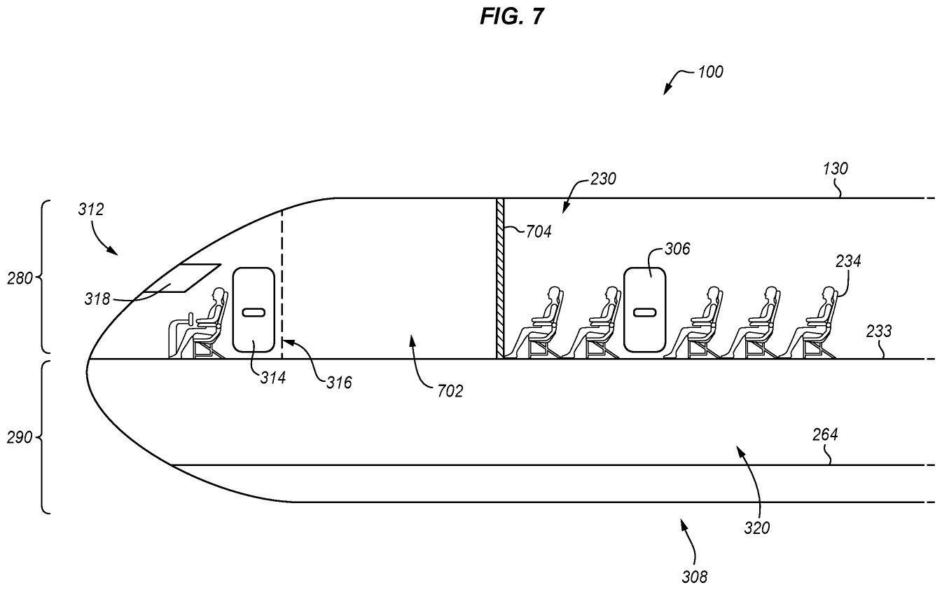

FIG. 7 illustrates a configuration for aircraft 100 whereby both a flight crew area 702 and aircraft cabin 230 are positioned within upper section 280 of fuselage 130. In particular, flight crew area 702 is positioned above or on floor 233, which forms one boundary of aircraft cabin 230 and flight crew area 702. Flight crew area 702 may include various features previously described for flight crew area 302, including cockpit 316, window 318, and door 314. In this embodiment, flight crew area 702 is isolated from aircraft cabin 230 by a bulkhead wall 704. Bulkhead wall 704 is a continuous surface that extends from floor 233 to fuselage 130 within upper section 280, and does not include any openings that are sized for a person to cross bulkhead wall 704 One advantage of the configuration illustrated in FIG. 7 is that cargo area 320 is larger, thereby allowing aircraft 100 to carry more cargo.

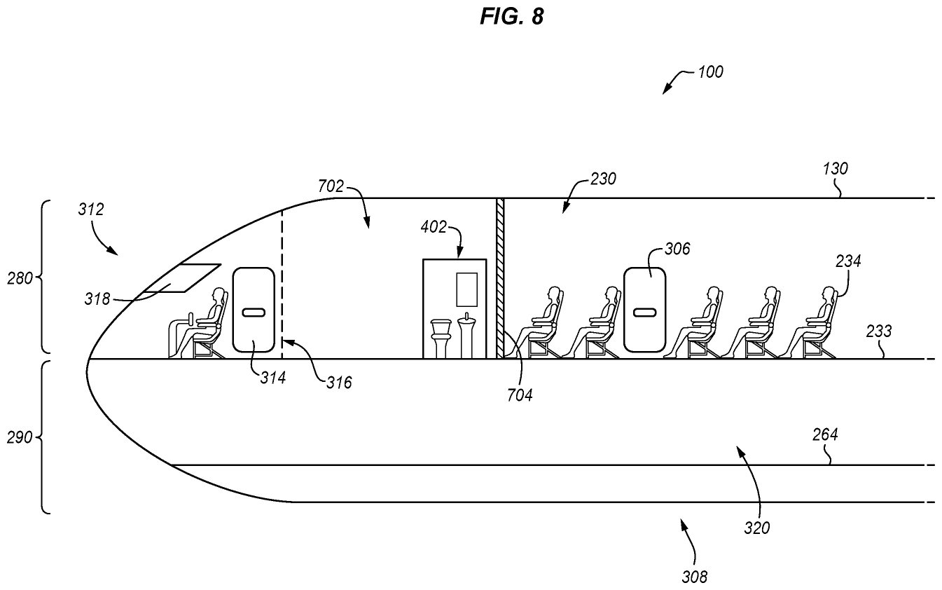

FIG. 8 illustrates a configuration for aircraft 100 whereby flight crew area 702 further includes lavatory 402 for the flight crew. Lavatory 402 has been previously described with respect to flight crew area 302.

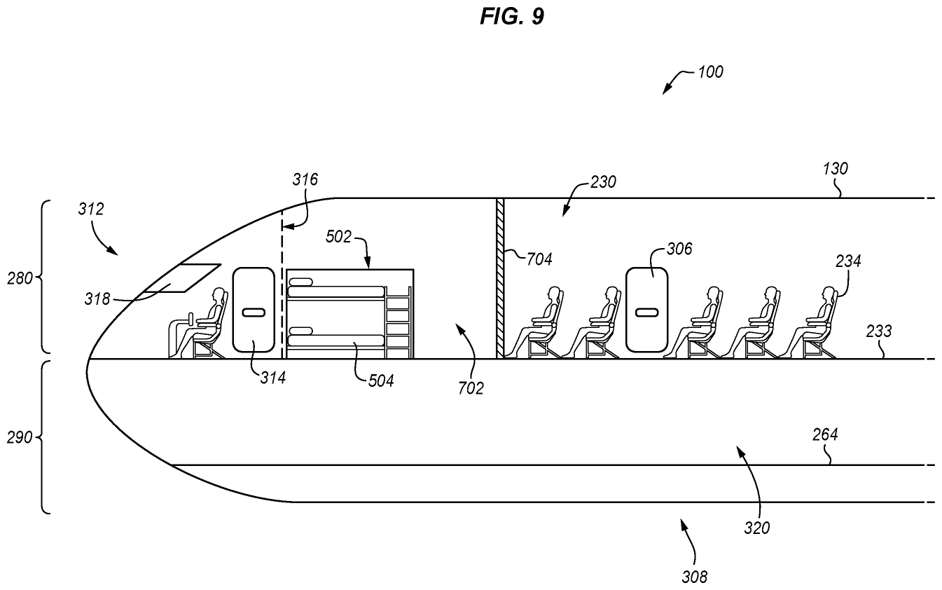

FIG. 9 illustrates a configuration for aircraft 100 whereby flight crew area 702 includes rest area 502 for the flight crew. Rest area 502 has been previously described with respect to flight crew area 302.

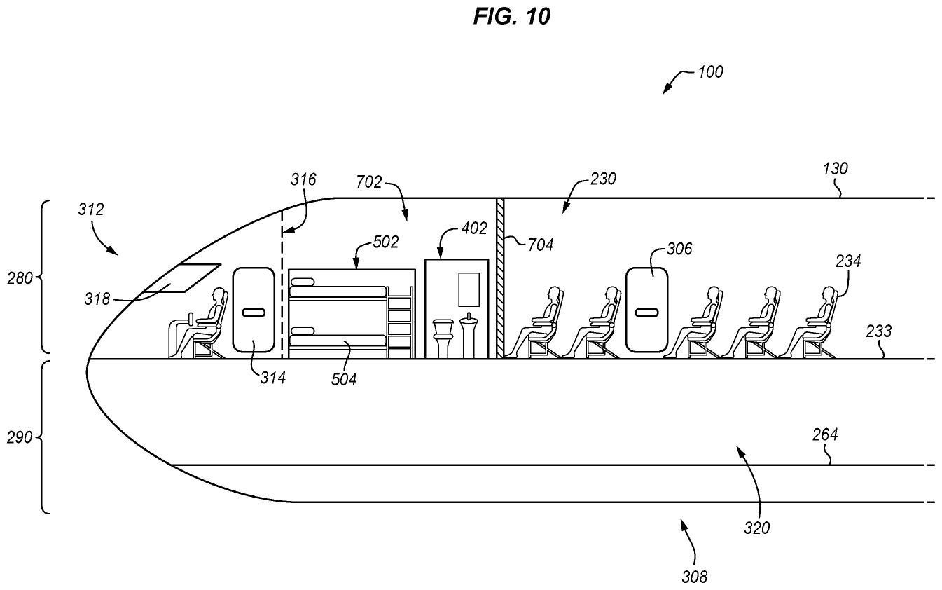

FIG. 10 illustrates a configuration for aircraft 100 whereby flight crew area 702 includes both lavatory 402 and rest area 502.

Although flight crew area 302 and/or flight crew area 702 have been illustrated as having a specific relationship with respect to cargo area 320, aircraft cabin 230, floor 233, cargo floor 264, and front 312 of aircraft 100, one of ordinary skill in the art will recognize that flight crew area 302 and/or flight crew area 702 may be located at different locations within aircraft 100 in other embodiments. For instance, when exterior cameras are used and window 318 is removed, no particular constraint exists where cockpit 316 is located within fuselage 130.

Utilizing door 314, flight crews can access flight crew area 302 and/or flight crew area 702, while preventing entry by unauthorized persons from aircraft cabin 230. As door 314 is inaccessible during flight operations, flight crew area 302 and/or flight crew area 702 are effectively isolated from aircraft cabin 230. This improves the security of flight crew area 302 and/or flight crew area 702.

Although specific embodiments were described herein, the scope is not limited to those specific embodiments. Rather, the scope is defined by the following claims and any equivalents thereof.

What is claimed is:

1. An aircraft, comprising:
an aircraft cabin that is configured for passenger seating; and
a flight crew area inaccessible from the aircraft cabin, the flight crew area including:
a cockpit; and
a door opening directly to an exterior of the aircraft that is sized for a person,
wherein the flight crew area is only accessible via the door.

2. The aircraft of claim 1, wherein:
the flight crew area further includes a rest area for a flight crew.

3. The aircraft of claim 2, wherein:
the rest area includes beds for the flight crew.

4. The aircraft of claim 1, wherein:
the flight crew area further includes a lavatory for a flight crew.

5. The aircraft of claim 1, wherein:
the cockpit further includes a window to the exterior of the aircraft.

6. The aircraft of claim 1, wherein:
the cockpit does not include a window to the exterior of the aircraft.

7. The aircraft of claim 1, wherein:
the flight crew area and the aircraft cabin are both positioned within an upper section of a fuselage of the aircraft.

8. The aircraft of claim 1, wherein:
the aircraft cabin is positioned within an upper section of a fuselage of the aircraft; and
the flight crew area is positioned within a lower section of the fuselage.

9. The aircraft of claim 8, wherein:
the aircraft cabin includes an observation window that is proximate to a front of the aircraft.

10. An aircraft, comprising:
a flight crew area, including:
a cockpit that includes a door that opens directly to an exterior of the aircraft; and
a lavatory accessible from the cockpit,
wherein the cockpit is only accessible via the door.

11. The aircraft of claim 10, wherein:
the flight crew area further includes a rest area for a flight crew.

12. The aircraft of claim 11, wherein:
the rest area includes beds for the flight crew.

13. The aircraft of claim 10, wherein:
the cockpit further includes a window to the exterior of the aircraft.

14. The aircraft of claim 10, wherein:
the cockpit does not include a window to the exterior of the aircraft.

15. The aircraft of claim 10, wherein:
the flight crew area is positioned below a lower section of a fuselage of the aircraft.

16. An aircraft, comprising:
a cockpit that includes a door that opens directly to an exterior of the aircraft; and
a lavatory accessible only from the cockpit,
wherein the cockpit is only accessible on the aircraft via the door.

17. The aircraft of claim 16, further comprising:
a rest area for a flight crew that is only accessible from the cockpit.

18. The aircraft of claim 17, wherein:
the rest area includes beds for the flight crew.

19. The aircraft of claim 16, wherein:
the cockpit does not include a window to the exterior of the aircraft.

20. The aircraft of claim 16, wherein:
cockpit is positioned below an aircraft cabin of the aircraft.
